(19) United States
(12) Patent Application Publication
(10) Pub. No.: US 2011/0238681 A1
(43) Pub. Date: Sep. 29, 2011

(54) Apparatus and Method for Storing, Searching and Retrieving an Object From a Document Repository Using Word Search and Visual Image

(76) Inventors: Basker S. Krishnan, San Marino, CA (US); Hanoz J. Kateli, Monrovia, CA (US); Bryan Heesch, Areadia, CA (US)

(21) Appl. No.: 12/730,443

(22) Filed: Mar. 24, 2010

(51) Int. Cl. G06F 17/30

(52) U.S. Cl. 707/758; 707/E17.008; 707/E17.014; 707/E17.02

(57) ABSTRACT

An apparatus and method for creating an association between a word and an object comprising creating an object identification (ID); assigning a link ID to the object ID; determining whether a word in the object is part of a word list; performing either a) adding the word to the word list and creating a unique word ID for the word, or b) gathering a word ID associated with the word; and associating either the unique word ID or the word ID to the link ID. In one aspect, the apparatus and method search for an object based on word search and visual image by searching for a word ID associated with a word in a word list; searching for at least one link ID associated with the word ID; associating the at least one link ID with an object ID; and visually displaying the object associated with the object ID.

### FIELD

This disclosure relates generally to apparatus and methods for searching and retrieving objects in a database. More particularly, the disclosure relates to storing, searching and retrieving an object (e.g., a document) in a database using word search and visual image.

### BACKGROUND

In current document files, it is known that many documents with similar or even identical words exist. Thus, with the commonality of words and phrases in different documents or even different versions of the documents, it is time consuming to find an exact document quickly and efficiently. Often, a keyword search could produce a list of many documents with the same word and even include all the various versions of the different documents containing the keyword. This is especially problematic if the keyword used in the search is a common word for a particular application.

### SUMMARY

Disclosed is an apparatus and method for storing, searching and retrieving objects (e.g., documents) in a database using word search and visual image. According to one aspect, a method for creating an association between a word and an object, the method comprising creating an object identification (ID) for an object; assigning a link identification (ID) to the object ID; determining for a word in the object whether the word is part of a word list; performing either a) adding the word to the word list if the word is not part of the word list and creating a unique word ID for the word; or b) gathering a word identification (ID) associated with the word if the word is part of the word list; and associating either the unique word ID or the word ID to the link ID.

According to another aspect, a method for searching for an object based on word search and visual image, the method comprising searching for a word identification (ID) associated with a word in a word list; searching for at least one link identification (ID) associated with the word ID; associating the at least one link ID with an object ID; and visually displaying the object associated with the object ID.

According to another aspect, an apparatus for creating an association between a word and an object, the apparatus comprising a processor and a memory, the memory containing program code executable by the processor for performing the following: creating an object identification (ID) for an object; assigning a link identification (ID) to the object ID; determining for a word in the object whether the word is part of a word list; performing either a) adding the word to the word list if the word is not part of the word list and creating a unique word ID for the word; or b) gathering a word identification (ID) associated with the word if the word is part of the word list; and associating either the unique word ID or the word ID to the link ID.

According to another aspect, an apparatus for searching for an object based on word search and visual image, the apparatus comprising a processor and a memory, the memory containing program code executable by the processor for performing the following: searching for a word identification (ID) associated with a word in a word list; searching for at least one link identification (ID) associated with the word ID; associating the at least one link ID with an object ID; and visually displaying the object associated with the object ID.

According to another aspect, an apparatus for creating an association between a word and an object, the method comprising creating an object identification (ID) for an object; assigning a link identification (ID) to the object ID; determining for a word in the object whether the word is part of a word list; performing either a) adding the word to the word list if the word is not part of the word list and creating a unique word ID for the word; or b) gathering a word identification (ID) associated with the word if the word is part of the word list; and associating either the unique word ID or the word ID to the link ID.

According to another aspect, an apparatus for searching for an object based on word search and visual image, the method comprising searching for a word identification (ID) associated with a word in a word list; searching for at least one link identification (ID) associated with the word ID; associating the at least one link ID with an object ID; and visually displaying the object associated with the object ID.

According to another aspect, a computer-readable medium storing a computer program, wherein execution of the computer program is for: creating an object identification (ID) for an object; assigning a link identification (ID) to the object ID; determining for a word in the object whether the word is part of a word list; performing either a) adding the word to the word list if the word is not part of the word list and creating a unique word ID for the word; or b) gathering a word identification (ID) associated with the word if the word is part of the word list; and associating either the unique word ID or the word ID to the link ID.

According to another aspect, a computer-readable medium storing a computer program, wherein execution of the computer program is for: searching for a word identification (ID) associated with a word in a word list; searching for at least one link identification (ID) associated with the word ID; associating the at least one link ID with an object ID; and visually displaying the object associated with the object ID.

Advantages of the present disclosure include reducing the time it takes to search for an object (e.g., a document) by efficiently using word search and visual image of the object to accurately locate the object in a time efficient manner.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of an identification network 100 in accordance with the present disclosure.

FIG. 2 illustrates an example flow diagram for creating an association between a word and an object (e.g., a document).

FIG. 3 illustrates an example flow diagram for searching for an object (e.g., a document) based on word search and visual image.

FIG. 4 illustrates an example of a device comprising a processor in communication with a memory for executing the algorithms described in FIGS. 2 and/or 3.

FIG. 5 illustrates an example of a device suitable for creating an association between a word and an object (e.g., document).

FIG. 6 illustrates an example of a device suitable for searching for an object (e.g., document) based on word search and visual image.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

A search may be based on not just words contained in a document, but also the user's memory of a visual image of the document and/or the approximate date of the document. For example, different documents or versions of a same document may contain many identical keywords. However, the visual images of the first page of different document types may differ. Thus, there's a need for a search approach that can utilize the aspects of key word searching and visual images of the document and/or the approximate date of the document being searched to quickly and efficiently locate the document in a document repository (e.g., database.). One skilled in the art would understand that a document repository may include an electronic repository or an electronic database.

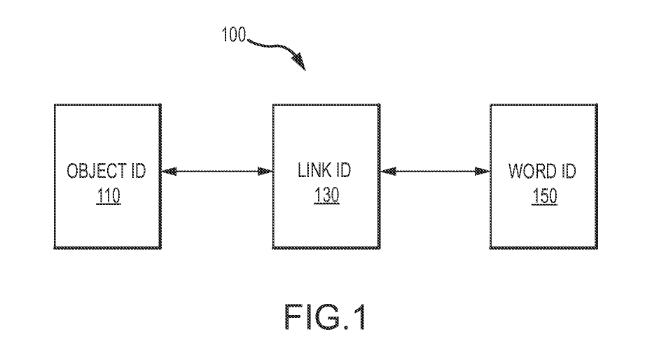

FIG. 1 illustrates an example of an identification network 100 in accordance with the present disclosure. In one aspect, the identification network 100 comprises three different types of identifications (ID), an object identification 110, a link identification 130 and a word identification. A word list is created such that every unique word in the word list is assigned a unique word identification (word ID). In one example, the word list is presented in a table format or referred to as a word table. In one example, each unique word is assigned its own unique word ID such that variations of the word would be assigned different word IDs. For example, the words “swing” and “swinging” would have different word IDs. In another example, words of the same root but varying only in grammatical tense will be assigned the same word ID. In this latter example, the words “swing” and “swinging” would have the same word ID. One skilled in the art would understand that there are various rules for assigning the word IDs which may be based, for example on particular categories or types of documents, particular words, application or usage and/or user choice, etc. Thus, one skilled in the art would understand that many different rules for assigning the word IDs may be used without affecting the spirit or scope of the present disclosure.

A link identification (ID) associates a word ID with an object identification (ID). Each word in the list (i.e., table) is assigned a word ID according to pre-defined assignment rules. A word ID can in turn be associated with multiple link IDs with each link ID associated with an object ID. Thus, in one example, the word “blood” is assigned a word ID. Its word ID is associated with 5 link IDs which correspond to 5 object IDs.

An object ID identifies an object. Various meanings of an object can be defined without affecting the scope or spirit of the present disclosure. An object is defined according to user choice, application or usage, category or type of documents, etc. For example, an object could be defined as a business entity and/or include business subsidiaries. An object would be defined as a client group or client subgroup. In another aspect, an object could be defined as a category of documents, for example, all banking statements belonging to a particular business entity or client. In another example, an object could be defined as a type of document, such as but not limited to, e-mails, memos, letters, charts, spreadsheets, etc. In another example, an object is a document within a repository of documents. One skilled in the art would understand that how an object is defined can be based on user choice, application or usage needs, categories and types of documents, etc. without affecting the spirit or scope of the present disclosure.

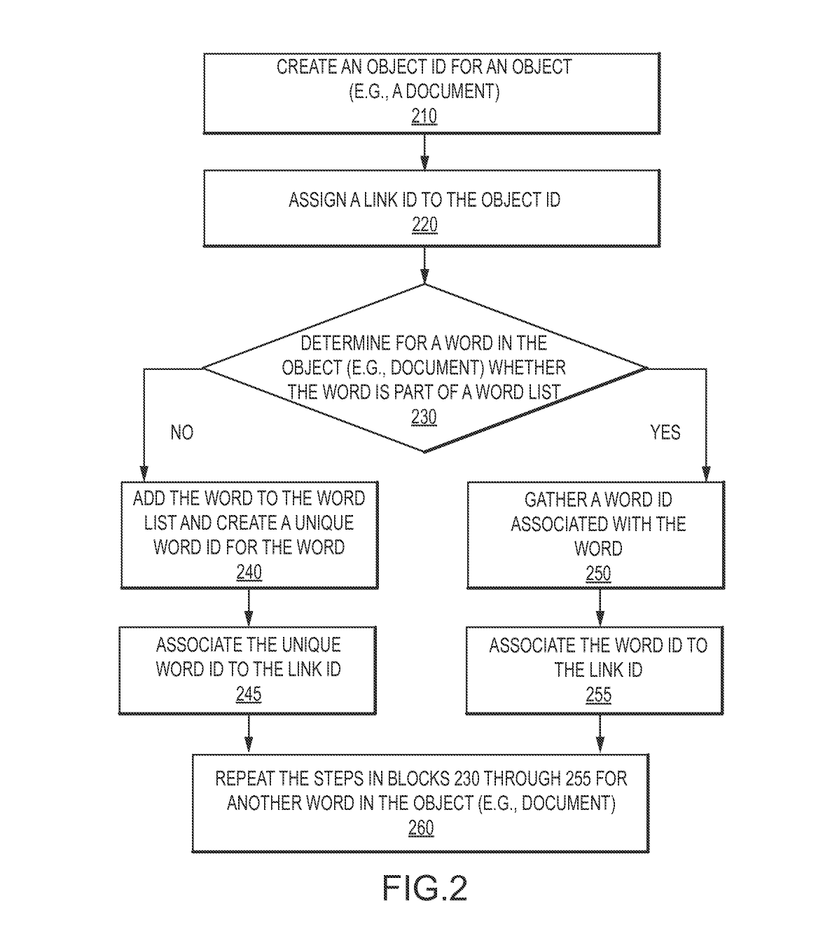

FIG. 2 illustrates an example flow diagram for creating an association between a word and an object. In block 210, create an object ID for an object (e.g., a document). In one aspect, the object ID is presented in the format of a series of numbers which in turn is associated with a set of information for the document. In one aspect, the object ID includes one or more of the following information associated with the document: business entity, business subsidiary, business department, client or sub-client, document types, additional identifying information, date of the document, meta data associated with the document, etc. A document may be a text document, an image document or a combination text and image document, etc. In one example, a document includes a single page paper document, a multiple page paper document (a.k.a. a stapled group), or a digital document file (created and stored digitally), etc. In one example the single page paper document or the multiple page paper document is scanned and stored electronically. A document may be of various document types (e.g., e-mails, letters, memos, charts, graphic presentations, etc.). In one example, the object ID of a document includes the following information: business entity (e.g., a doctor's office), the department (e.g., lab department), sub-client (e.g., a patient's record), document type (e.g., lab test results) and additional identifying information (e.g., date of lab test).

Following block 210, in block 220, assign a link ID to the object ID. In one aspect, the link ID contains information associated with its corresponding object ID. For example, a link ID may also include the same document type information found in its corresponding object ID. In another example, the link ID may also include the business entity information associated with its corresponding object ID. One skilled in the art would understand that other information associated with its corresponding object ID may be included as part of the link ID.

Following block 220, in block 230, determine for a word in the object (e.g., document) whether the word is part of a word list. If the word is not part of the word list, in block 240, add the word to the word list and create a unique word ID for the word. Following block 240, in block 245, associate the unique word ID to the link ID. If the word is part of the word list, in block 250, gather a word ID associated with the word. Following block 250, in block 255, associate the word ID to the link ID. Once a word ID is associated to the link ID, the word ID is then also associated with an object ID. Thus, the word associated with the word ID is associated with the object (e.g., document) associated with the object ID.

Following either block 245 or 255, in block 260, repeat the steps in blocks 230 through 255 for another word in the object (e.g., document). In one aspect, the step in block 260 is repeated until all the words to be determined are processed as described in the example flow diagram of FIG. 2. Although the term “word” is used in the description of FIG. 2, the term “word” can include “word phrases” and is not confined to a single word.

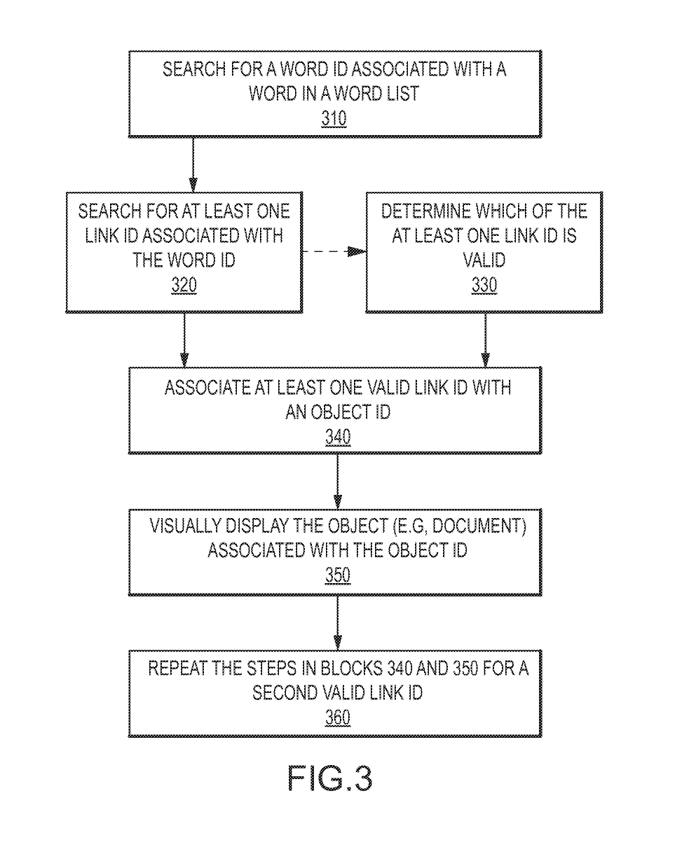

FIG. 3 illustrates an example flow diagram for searching for an object (e.g., document) based on word search and visual image. In block 310, search for a word ID associated with a word in a word list. Following block 310, in block 320, search for at least one link ID associated with the word ID. Following block 320, in block 330, determine which of the at least one link ID is valid. For example, if there are 5 link IDs associated with the word ID, look to the information associated with each of the 5 link IDs. For example, if only 3 of the 5 link IDs indicate that they are associated with e-mails and an e-mail is the document type being searched, then the 3 link IDs are considered valid while the other 2 link IDs are considered invalid. In one example, if only 3 of the 5 link IDs indicate they are associated with a category/section being searched, then only the 3 link IDs are considered valid. Other information associated with the link IDs (as, for example, described above) may be used to determine whether a link ID is valid or not. In one aspect, the step in block 330 is optional as all the link IDs associated with a word ID may be considered valid upon user's choice or other predefined criteria.

Following either blocks 320 or 330, in block 340, associate at least one valid link ID with an object ID. Following block 340, in block 350, visually display the object (e.g., document) associated with the object ID. In one example, the object ID is associated with an entire document and the visual display may start with the cover page of the document. Paging through the document is an available option. In another example, the object ID is associated with a first portion of the document displaying the word, and paging to subsequent portions of the document displaying the word is an available option. Various visual display options of the document, including but not limited to, thumbnail display, truncated display, full page display (e.g., the first page of a document), etc., are available without affecting the spirit or scope of the present disclosure. In one example, a date associated with the document is also visually displayed. In one example, the page quantity of the document is also visually displayed. In yet another example, a meta data associated with the document is visually displayed. Following block 350, in block 360, repeat the steps in blocks 340 and 350 for a second valid link ID. In one aspect, the step of block 360 is repeated until all the valid link IDs have been exhausted.

One skilled in the art would understand that the steps disclosed in the example flow diagrams in FIGS. 2 and 3 can be interchanged in their order without departing from the scope and spirit of the present disclosure. Also, one skilled in the art would understand that the steps illustrated in the flow diagrams are not exclusive and other steps may be included or one or more of the steps in the example flow diagrams may be deleted without affecting the scope and spirit of the present disclosure.

Those of skill would further appreciate that the various illustrative components, logical blocks, modules, and/or algorithm steps described in connection with the examples disclosed herein may be implemented as electronic hardware, firmware, computer software, or combinations thereof To clearly illustrate this interchangeability of hardware, firmware and software, various illustrative components, blocks, modules, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art.

In one or more examples, the steps or functions described herein may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

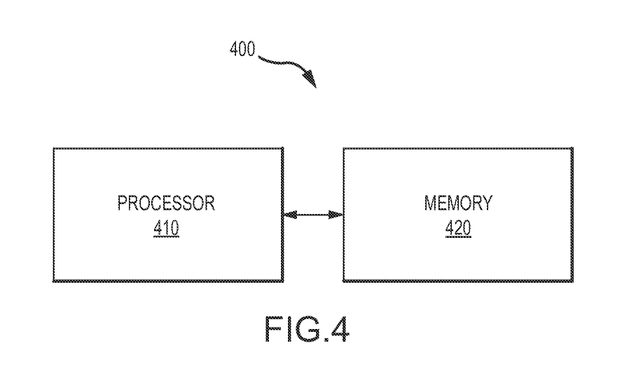

In one example, the illustrative components, flow diagrams, logical blocks, modules and/or algorithm steps described herein are implemented or performed with one or more processors. In one aspect, a processor is coupled with a memory which stores data, metadata, program instructions, etc. to be executed by the processor for implementing or performing the various flow diagrams, logical blocks and/or modules described herein. FIG. 4 illustrates an example of a device 400 comprising a processor 410 in communication with a memory 420 for executing the algorithms described in FIGS. 2 and/or 3. In one example, the device 400 is used to implement the algorithm illustrated in FIG. 2. In another example, the device 400 is used to implement the algorithm illustrated in FIG. 3. In one aspect, the memory 420 is located within the processor 410. In another aspect, the memory 420 is external to the processor 410. In one aspect, the processor includes circuitry for implementing or performing the various flow diagrams, logical blocks and/or modules described herein.

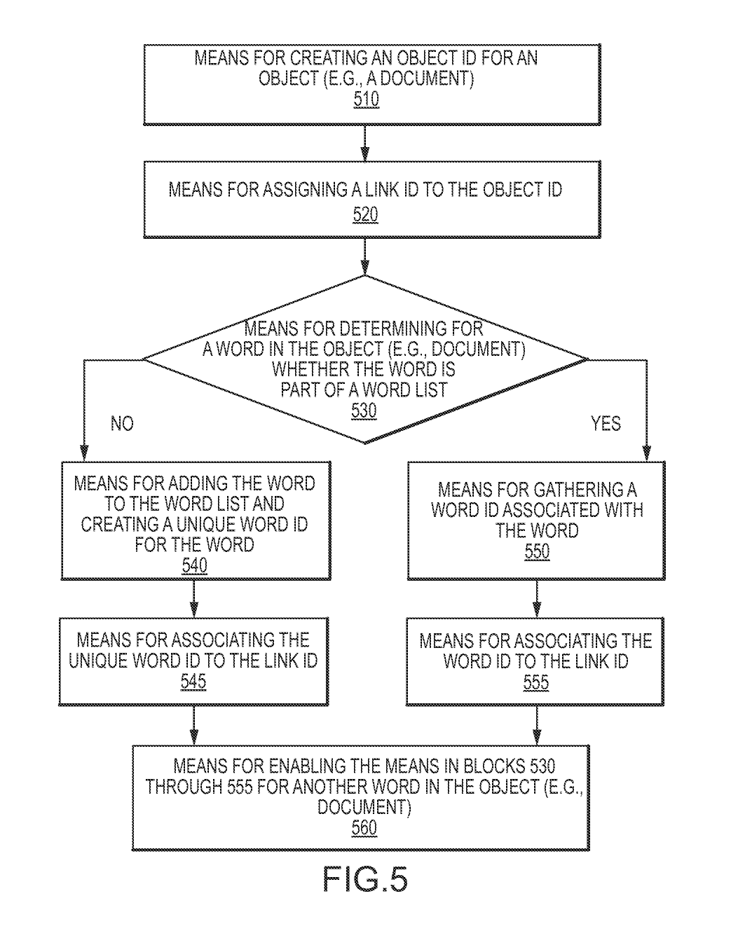

FIG. 5 illustrates an example of a device 500 suitable for creating an association between a word and an object (e.g., document). In one aspect, the device 500 is implemented by at least one processor comprising one or more modules configured to provide different aspects of creating an association between a word and an object (e.g., document) as described herein in blocks 510, 520, 530, 540, 545, 550, 555, and 560. For example, each module comprises hardware, firmware, software, or any combination thereof In one aspect, the device 500 is also implemented by at least one memory in communication with the at least one processor.

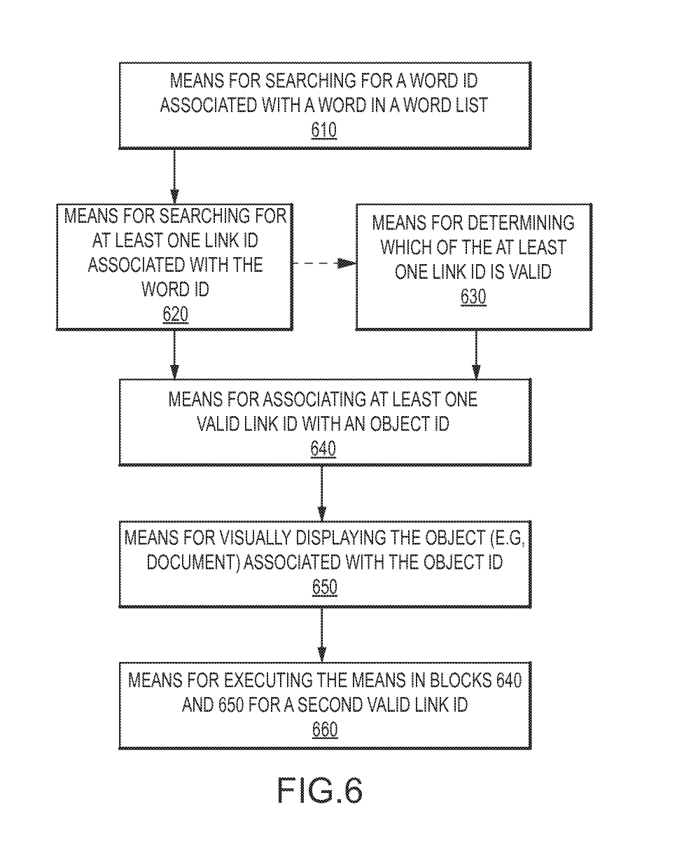

FIG. 6 illustrates an example of a device 600 suitable for searching for an object (e.g., document) based on word search and visual image. In one aspect, the device 600 is implemented by at least one processor comprising one or more modules configured to provide different aspects of creating an association between a word and an object (e.g., document) as described herein in blocks 610, 620, 630, 640, 650, and 660. For example, each module comprises hardware, firmware, software, or any combination thereof In one aspect, the device 600 is also implemented by at least one memory in communication with the at least one processor.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for creating an association between a word and an object, the method comprising:
creating an object identification (ID) for an object;
assigning a link identification (ID) to the object ID;
determining for a word in the object whether the word is part of a word list;
performing one of the following:
a) adding the word to the word list if the word is not part of the word list and creating a unique word ID for the word; or
b) gathering a word identification (ID) associated with the word if the word is part of the word list; and
associating either the unique word ID or the word ID to the link ID.

2. The method of claim 1 wherein the object ID is presented in a format of a series of numbers associated with a set of information for the object.

3. The method of claim 1 wherein the object ID includes one or more of the following information associated with the object: business entity, business subsidiary, business department, client or sub-client information or document types.

4. The method of claim 3 wherein the object is a document comprising one or more of the following document types: e-mail, letter, memo, chart or graphic presentation.

5. The method of claim 1 wherein the link ID contains at least one information associated with the object that is contained in the object ID.

6. A method for searching for an object based on word search and visual image, the method comprising:
searching for a word identification (ID) associated with a word in a word list;
searching for at least one link identification (ID) associated with the word ID;
associating the at least one link ID with an object ID; and
visually displaying the object associated with the object ID.

7. The method of claim 6 further comprising determining which of the at least one link ID is valid.

8. The method of claim 7 wherein the object ID is associated with a document and the document is visually displayed starting with a first page of the document.

9. The method of claim 7 wherein the object ID is associated with a first portion of a document and the first portion of document displaying the word is visually displayed.

10. The method of claim 9 wherein the visually displaying step includes paging to at least one subsequent portion of the document displaying the word.

11. An apparatus for creating an association between a word and an object, the apparatus comprising a processor and a memory, the memory containing program code executable by the processor for performing the following:
creating an object identification (ID) for an object;
assigning a link identification (ID) to the object ID;
determining for a word in the object whether the word is part of a word list;
performing one of the following:
a) adding the word to the word list if the word is not part of the word list and creating a unique word ID for the word; or
b) gathering a word identification (ID) associated with the word if the word is part of the word list; and
associating either the unique word ID or the word ID to the link ID.

12. The apparatus of claim 11 wherein the object ID is presented in a format of a series of numbers associated with a set of information for the object.

13. The apparatus of claim 11 wherein the object ID includes one or more of the following information associated with the object: business entity, business subsidiary, business department, client or sub-client information or document types.

14. The apparatus of claim 13 wherein the object is a document comprising one or more of the following document types: e-mail, letter, memo, chart or graphic presentation.

15. The apparatus of claim 11 wherein the link ID contains at least one information associated with the object that is contained in the object ID.

16. An apparatus for searching for an object based on word search and visual image, the apparatus comprising a processor and a memory, the memory containing program code executable by the processor for performing the following:
searching for a word identification (ID) associated with a word in a word list;
searching for at least one link identification (ID) associated with the word ID;
associating the at least one link ID with an object ID; and
visually displaying the object associated with the object ID.

17. The apparatus of claim 16 wherein the memory further comprising program code for determining which of the at least one link ID is valid.

18. The apparatus of claim 17 wherein the object ID is associated with a document and the document is visually displayed starting with a first page of the document.

19. The apparatus of claim 17 wherein the object ID is associated with a first portion of a document and the first portion of document displaying the word is visually displayed.

20. The apparatus of claim 19 wherein the program code for performing visually displaying further includes program code for paging to at least one subsequent portion of the document displaying the word.

21. An apparatus for creating an association between a word and an object, the method comprising:
creating an object identification (ID) for an object;
assigning a link identification (ID) to the object ID;
determining for a word in the object whether the word is part of a word list;
performing one of the following:
a) adding the word to the word list if the word is not part of the word list and creating a unique word ID for the word; or
b) gathering a word identification (ID) associated with the word if the word is part of the word list; and
associating either the unique word ID or the word ID to the link ID.

22. The apparatus of claim 21 wherein the object ID is presented in a format of a series of numbers associated with a set of information for the object.

23. The apparatus of claim 21 wherein the object ID includes one or more of the following information associated with the object: business entity, business subsidiary, business department, client or sub-client information or document types.

24. The apparatus of claim 23 wherein the object is a document comprising one or more of the following document types: e-mail, letter, memo, chart or graphic presentation.

25. The apparatus of claim 21 wherein the link ID contains at least one information associated with the object that is contained in the object ID.

26. An apparatus for searching for an object based on word search and visual image, the method comprising:
searching for a word identification (ID) associated with a word in a word list;
searching for at least one link identification (ID) associated with the word ID;
associating the at least one link ID with an object ID; and
visually displaying the object associated with the object ID.

27. The apparatus of claim 26 further comprising determining which of the at least one link ID is valid.

28. The apparatus of claim 27 wherein the object ID is associated with a document and the document is visually displayed starting with a first page of the document.

29. The apparatus of claim 27 wherein the object ID is associated with a first portion of a document and the first portion of document displaying the word is visually displayed.

30. The apparatus of claim 29 wherein the visually displaying step includes paging to at least one subsequent portion of the document displaying the word.

31. A computer-readable medium storing a computer program, wherein execution of the computer program is for:
creating an object identification (ID) for an object;
assigning a link identification (ID) to the object ID;
determining for a word in the object whether the word is part of a word list;
performing one of the following:
a) adding the word to the word list if the word is not part of the word list and creating a unique word ID for the word; or
b) gathering a word identification (ID) associated with the word if the word is part of the word list; and
associating either the unique word ID or the word ID to the link ID.

32. A computer-readable medium storing a computer program, wherein execution of the computer program is for:
searching for a word identification (ID) associated with a word in a word list;
searching for at least one link identification (ID) associated with the word ID;
associating the at least one link ID with an object ID; and
visually displaying the object associated with the object ID.
